(19) United States
(12) Patent Application Publication
(10) Pub. No.: US 2018/0155166 A1
(43) Pub. Date: Jun. 7, 2018

(54) Pump Jack Pole, System and Method

(71) Applicants: Daniel C. Mora, Transfer, PA (US); Brian R. Fisher, Greenville, PA (US)

(72) Inventors: Daniel C. Mora, Transfer, PA (US); Brian R. Fisher, Greenville, PA (US)

(73) Assignee: Werner Co.

(21) Appl. No.: 15/369,421

(22) Filed: Dec. 5, 2016

(51) Int. Cl. B66F 1/02; A63B 27/00; B21J 15/02

(52) U.S. Cl. CPC B66F 1/02; B21J 15/025; A63B 27/00

(57) ABSTRACT

A pump jack pole having an aluminum extrusion having a first side and a second side. The pole has a rubber or composite layer disposed along the second side of the extrusion. The pole has a rivet that extends through the rubber or composite layer and a hole in the extrusion to bold the rubber or composite layer to the second side of the extrusion. The extrusion has a barb disposed on the first side of the extrusion about the hole. An assembly. A riveting machine. A pump jack pole system. A method for producing a pump jack pole.

### FIELD OF THE INVENTION

The present invention is related to an assembly, such as a pump jack pole, in which a rivet is used to hold a first element, such as a rubber or composite layer, to a second layer, such as an aluminum extrusion. (As used herein, references to the “present invention” or “invention” relate to exemplary embodiments and not necessarily to every embodiment encompassed by the appended claims.) More specifically, the present invention is related to an assembly, such as a pump jack pole, in which a rivet is used to hold a first element, such as a rubber or composite layer, to a second layer, such as an aluminum extrusion, where the rivet is a self-punching aluminum alloy rivet that forms a work hardened hole in the extrusion and a barb around the whole when the rivet punches through the rubber or composite layer and the extrusion to hold the rubber or composite layer and the extrusion together.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

It is common practice when producing a pump jack pole to use rivets to attach a rubber layer along which a pump jack travels to an aluminum extrusion. The riveting process typically involves pre-drilling holes in the extrusion to receive the rivets, thus requiring at least a two-step process; pre-drilling the holes and placing the rivets in the holes. It would be advantageous in regard to production costs and time to reduce this two-step process to single step. Furthermore, because holes are required to receive the rivets, there is the concern that cracking emanating from the holes in whatever steps possible to minimize or preclude cracking from the holes is desirable.

### BRIEF SUMMARY OF THE INVENTION

The present invention pertains to a pump jack pole. The pole comprises an aluminum extrusion having a first side and second side. The pole comprises a rubber or composite layer disposed along the second side of the extrusion. The pole comprises a rivet that extends through the rubber or composite layer and a hole in the extrusion to hold the rubber or composite layer to the second side of the extrusion. The extrusion has a barb disposed on the first side of the extrusion about the hole.

The present invention pertains to a pump jack pole. The pole comprises an aluminum extrusion having a first side and a second side. The pole comprises a rubber or composite layer disposed along the second side of the extrusion. The pole comprises a self-punching solid rivet that extends through the extrusion and the rubber or composite layer to hold the rubber or composite layer to the second side of the extrusion. The extrusion does not have a pre-drilled hole through which the rivet extends.

The present invention pertains to a pump jack pole. The pole comprises an aluminum extrusion having a first side and a second side. The pole comprises a rubber or composite layer disposed along the second side of the extrusion. The pole comprises a rivet that extends through the rubber or composite layer and the extrusion to hold the rubber or composite layer to the second side of the extrusion. The rivet has a rivet upset adjacent the first side of the extrusion.

The present invention pertains to a pump jack pole. The pole comprises an aluminum extrusion that begins to yield in shear around 600 lbs. having a first side and a second side. The pole comprises a rubber or composite layer disposed along the second side of the extrusion. The pole comprises a self-punching solid rivet that begins to yield in compression around 1,000 lbs. and extends through the rubber or composite layer and the extrusion to hold the rubber or composite layer to the second side of the extrusion. The extrusion not having a pre-drilled hole through which the river extends.

The present invention pertains to a pump jack pole. The pole comprises an aluminum extrusion having a first side and a second side. The pole comprises a rubber or composite layer disposed along the second side of the extrusion. The pole comprises a rivet that extends through the rubber or composite layer and a work hardened hole in the extrusion to hold the rubber or composite layer to the second side of the extrusion.

The present invention pertains to a method for forming a pump jack pole. The method comprises the steps of positioning a solid rivet held by a rivet machine over a rubber or composite layer disposed on a second side of an aluminum extrusion. There is the step of punching the solid rivet with the rivet machine through the rubber or composite layer and the extrusion thus forming with the rivet a work hardened hole in the extrusion and a barb disposed about the hole on a first side of the extrusion through which the rivet extends, with a rivet upset formed on an end of the rivet which is disposed above the barb by the end of the rivet-contacting an anvil of the rivet machine as the rivet is punched through the extrusion. The extrusion does not have a pre-drilled hole in which the solid rivet is disposed. There is the step of removing the rubber or composite layer that is held in place on the second side of the extrusion with the rivet extending through the rubber or composite layer and the extrusion from the rivet machine.

The present invention pertains to a pump Jack system. The system comprises a pump Jack pole comprising an aluminum extrusion having a first side and a second side, a rubber or composite layer disposed along the second side of the extrusion, and a rivet that extends through the rubber or composite layer and a hold in the extrusion to hold the rubber or composite layer to the second side of the extrusion. The extrusion has a barb disposed on the first side of the extrusion about the hole. The system comprises a pump Jack engaged with the pole so the pump Jack can move up and down the pole.

The present invention pertains to a pump jack pole. The pole comprises an aluminum extrusion having a first side and a second side. The pole comprises a rubber or composite layer disposed along the second side of the extrusion. The pole comprises a self-punching solid rivet that extends through a barb and work hardened hole in the extrusion to hold the rubber or composite layer to the second sale of the extrusion. The extrusion does not have a pre-drilled hole through which the rivet extends. The rivet has a rivet upset adjacent the first side of the extrusion. The barb disposed on the first side of the extrusion.

The present invention pertains to an assembly. The assembly comprises an aluminum extrusion having a first side and a second side. The assembly comprises a layer disposed along the second side of the extrusion. The assembly comprises a rivet that extends through the layer and a hole in the extrusion to hold the layer to the second side of the extrusion, the extrusion having a barb disposed on the first side of the extrusion about the hole.

The present invention pertains to a riveting machine. The riveting machine comprises a punch to push against a rivet and insert the rivet into an assembly. The riveting machine comprises an anvil having a flat top which the rivet contacts. The anvil has an inward channel with an inlet that extends through the anvil to the flat top and an outward channel with an outlet that extends from the flat top through the anvil. The riveting machine comprises a pressurized gas source that is connected to the inlet through which pressurized gas flows to the flat top and from the flat top through the outward channel to the outlet to evacuate debris at the flat top.

### BRIEF DESCRIPTION OF THE SEVERAL VIEWS OF THE DRAWING

In the accompanying drawings, the preferred embodiment of the invention and preferred methods of practicing the invention are illustrated in which:

FIG. 1 shows a cross-sectional view of a rivet holding a rubber or composite layer and the extrusion together.

FIG. 2 shows a front cross-sectional view of a pump jack pole of the present invention.

FIG. 3 and 4 show the rivet punching through the extrusion

FIG. 5 shows a pump jack system.

FIG. 6 shows a front perspective view of an anvil of the present invention.

FIG. 7 shows a rear perspective view of the anvil.

FIG. 8 shows a side cross-sectional view of the anvil.

FIG. 9 is a block diagram of a riveting machine of the present invention.

FIG. 10 shows a rivet with a tip having a dog point taper.

FIG. 11 shows a pump jack pole holding a pump jack holding scaffold.

### DETAILED DESCRIPTION OF THE INVENTION

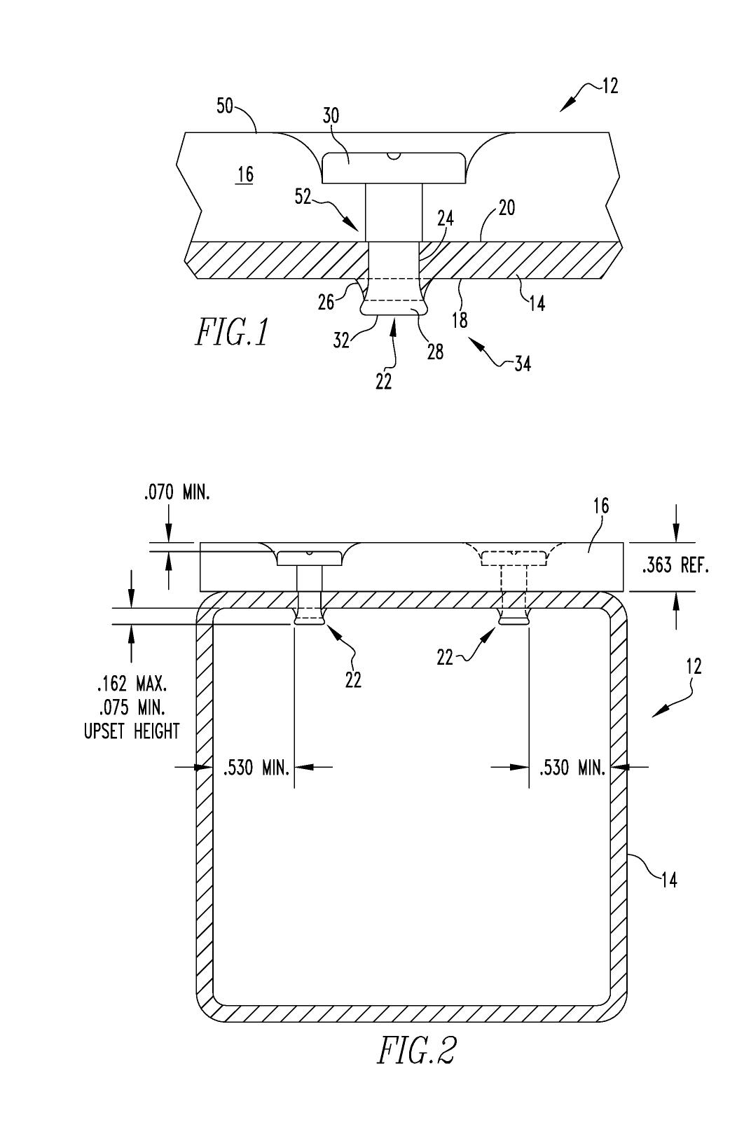

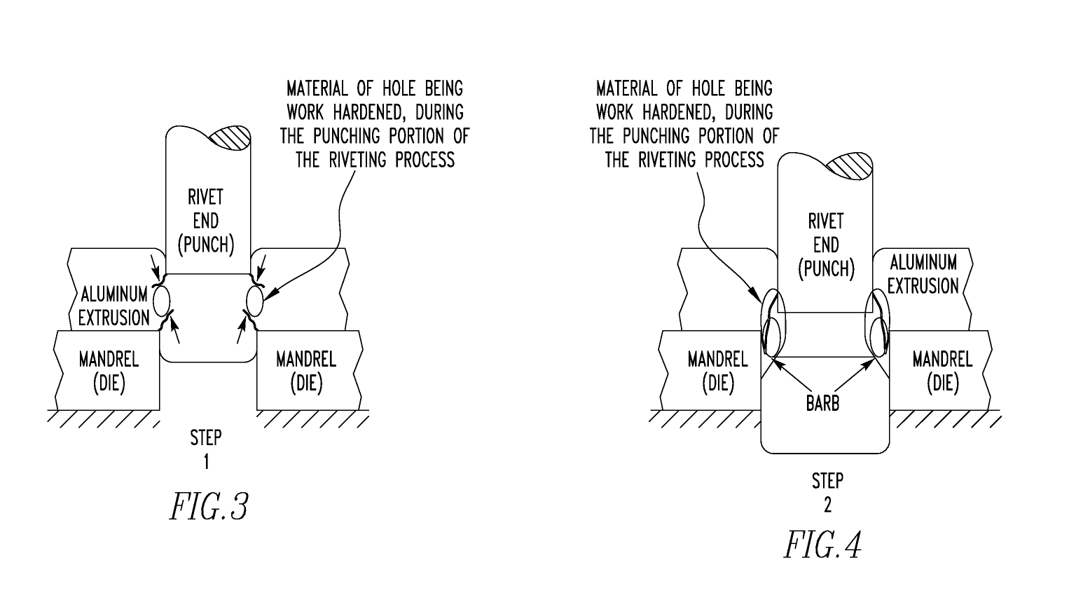

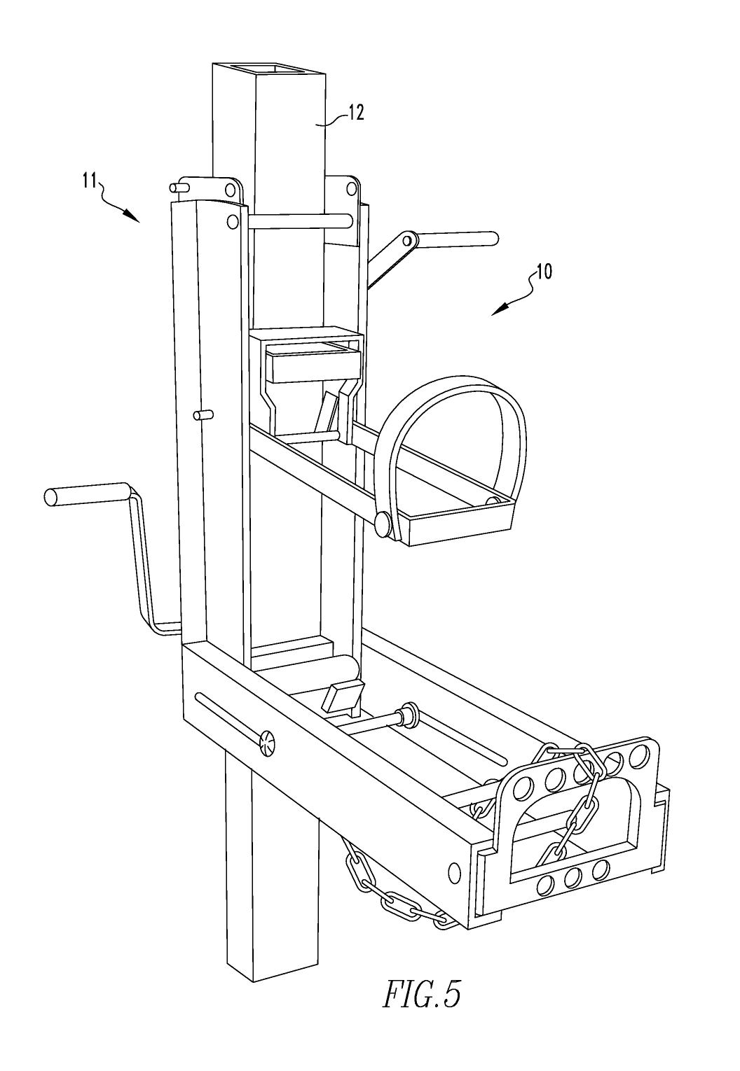

Referring now to the drawings wherein like reference numerals refer to similar or identical parts throughout the several views, and more specifically to FIGS. 1 and 2 thereof, there is shown a pump jack pole 12. The pole comprises an aluminum extrusion 14 having a first side 18 and a second side 20. The pole comprises a rubber or composite layer 16 disposed along the second side 20 of the extrusion 14. The pole comprises a rivet 22 that extends through the rubber or composite layer 16 and a hole 24 in the extrusion 14 to hold the rubber or composite layer 16 to the second side 20 of the extrusion 14. The extrusion 14 has a barb 26 disposed on the first side 18 of the extrusion 14 about the hole 24. FIG. 5 shows a pump jack 10 on a pump jack pole 12. FIG. 11 shows a pump jack 10 on a pump jack pole 12 holding scaffolding with a user pressing down on a pedal of the pump jack 10.

The rivet 22 may be a self-punching solid rivet 22. The rivet 22 may have a rivet upset 28 adjacent the first side 18 of the extrusion 14. The hole 24 in the extrusion 14 may be work hardened. The aluminum extrusion 14 may begin to yield in shear at less than 600 lbs. and the rivet 22 may begin to yield in compression around 1,000 lbs. The rivet 22 has a head 30 which may be disposed in the rubber or composite layer 16 below the rubber or composite layer's surface 50. The rivet 22 may have a diameter that is larger in the rubber or composite layer 16 than the diameter of the rivet 22 in the extrusion 14. The extrusion 14 may be a 6000 series aluminum and the rivet 22 may be a 7000 series aluminum alloy. The rivet 22 may have an interference fit with the extrusion 14 in the hole 24. The composite layer 16 may be rubber with two layers of fabric, with one layer on each side of the rubber. In one embodiment, the rubber can be a rubber grade 2 SBR (styrene butadiene rubber), with the fabric being a plane leave polyester (RFL treated). In a second embodiment, the rubber can be grade 2 Duraking 993 nitrile. Both of these composite layers are well known in the art and can be purchased.

The present invention pertains to a pump jack pole 12. The pole comprises an aluminum extrusion 14 having a first side 18 and a second side 20. The pole comprises a rubber or composite layer 16 disposed along the second side 20 of the extrusion 14. The pole comprises a self-punching solid rivet 22 that extends through the extrusion 14 and the rubber or composite layer 16 to hold the rubber or composite layer 16 to the second side 20 of the extrusion 14. The extrusion 14 does not have a pre-drilled hole 24 through which the rivet 22 extends.

The present invention pertains to a pump jack pole 12. The pole comprises an aluminum extrusion 14 having a first side 18 and a second side 20. The polo comprises a rubber or composite layer 16 disposed along the second side 20 of the extrusion 14. The pole comprises a rivet 22 that extends through the rubber or composite layer 16 and the extrusion 14 to hold the rubber or composite layer 16 to the second side 20 of the extrusion 14. The rivet 22 has a rivet upset 28 adjacent the first side 18 of the extrusion 14.

The present invention pertains to a pump jack pole 12. The pole comprises an aluminum extrusion 14 that begins to yield in shear around 600 lbs. having a first side 18 and a second side 20. The pole comprises a rubber or composite layer 16 disposed along the second side 20 of the extrusion 14. The pole comprises a self-punching solid rivet 22 that begins to yield in compression around 1,000 lbs. and extends through the rubber or composite layer 16 and the extrusion 14 to hold the rubber or composite layer 16 to the second side 20 of the extrusion 14. The extrusion 14 not having a pre-drilled hole 24 through which the river extends.

The present invention pertains to a pump jack pole 12. The pole comprises an aluminum extrusion 14 having a first side 18 and a second side 20. The pole comprises a rubber or composite layer 16 disposed along the second side 20 of the extrusion 14. The pole comprises a rivet 22 that extends through the rubber or composite layer 16 and a work hardened hole 24 in the extrusion 14 to hold the rubber or composite layer 16 to the second side 20 of the extrusion 14.

The present invention pertains to a method for forming a pump jack pole 12. The method comprises the steps of positioning a solid rivet 22 held by a rivet machine 36 over a rubber or composite layer 16 disposed on a second side 20 of an aluminum extrusion 14. There is the step of punching the solid rivet 22 with the rivet machine 36 through the rubber or composite layer 16 and the extrusion 14 thus forming with the rivet 22 a work hardened hole 24 in the extrusion 14 and a barb 26 disposed about the hole 24 on a first side 18 of the extrusion 14 through which the rivet 22 extends, with a rivet 22 upset formed on an end of the rivet 22 which is disposed above the barb 26 by the end of the rivet 22 contacting an anvil 38 of the rivet machine 36 as the rivet 22 is punched through the extrusion 14. The extrusion 14 does not have a pre-drilled hole 24 in which the solid rivet 22 is disposed. There is the step of removing the rubber or composite layer 16 that is held in place on the second side 20 of the extrusion 14 with the rivet 22 extending through the rubber or composite layer 16 and the extrusion 14 from the rivet machine 36.

There may be the step of removing extrusion 14 slug upset. The rivet 22 may have a tip 32 which is a dog point taper, and the punching step may include the step of punching the rivet 22 through the rubber or composite layer 16 with the tip 32 of the rivet 22 and forming the rivet upset 28 from the tip 32.

The present invention pertains to a pump jack 11, as shown in FIG. 5. The system 11 comprises a pump jack pole 12 comprising an aluminum extrusion 14 having a first side 18 and a second side 20, a rubber or composite layer 16 disposed along the second side 20 of the extrusion 14, and a rivet 22 that extends through the rubber or composite layer 16 and a hole 24 in the extrusion 14 to hold the rubber or composite layer 16 to the second side 20 of the extrusion 14. The extrusion 14 has a barb 26 disposed on the first side 18 of the extrusion 14 about the hole 24. The system 11 comprises a pump jack 10 engaged with the pole so the pump lack 10 can move up and down the pole.

The present invention pertains to a pump jack pole 12. The pole comprises an aluminum extrusion 14 having a first side 18 and a second side 20. The pole comprises a rubber or composite layer 16 disposed along the second side 20 of the extrusion 14. The pole comprises a self-punching solid rivet 22 that extends through a barb 26 and work hardened hole 24 in the extrusion 14 to hold the rubber or composite layer 16 to the second side 20 of the extrusion 14. The extrusion 14 does not have a pre-drilled hole 24 through which the rivet 22 extends. The rivet 22 has a rivet upset 28 adjacent the first side 18 of the extrusion 14. The barb 26 dispose on the first side 18 of the extrusion 14.

The present invention pertains to an assembly 34, as shown in FIG. 1. The assembly 34 comprises an aluminum extrusion 14 having a first side 18 and a second side 20. The assembly 34 comprises a layer 16 disposed along the second side 20 of the extrusion 14. The assembly 34 comprises a rivet 22 that extends through the layer 16 and a hole 24 in the extrusion 14 to hold the layer 16 to the second side 20 of the extrusion 14, the extrusion 14 having a barb 26 disposed on the first side 18 of the extrusion 14 about the hole 24. The rivet 22 yields in compression at a greater load then the extrusion 14 or the layer 16 yields in shear. The layer 16 may be a rubber or composite layer 16.

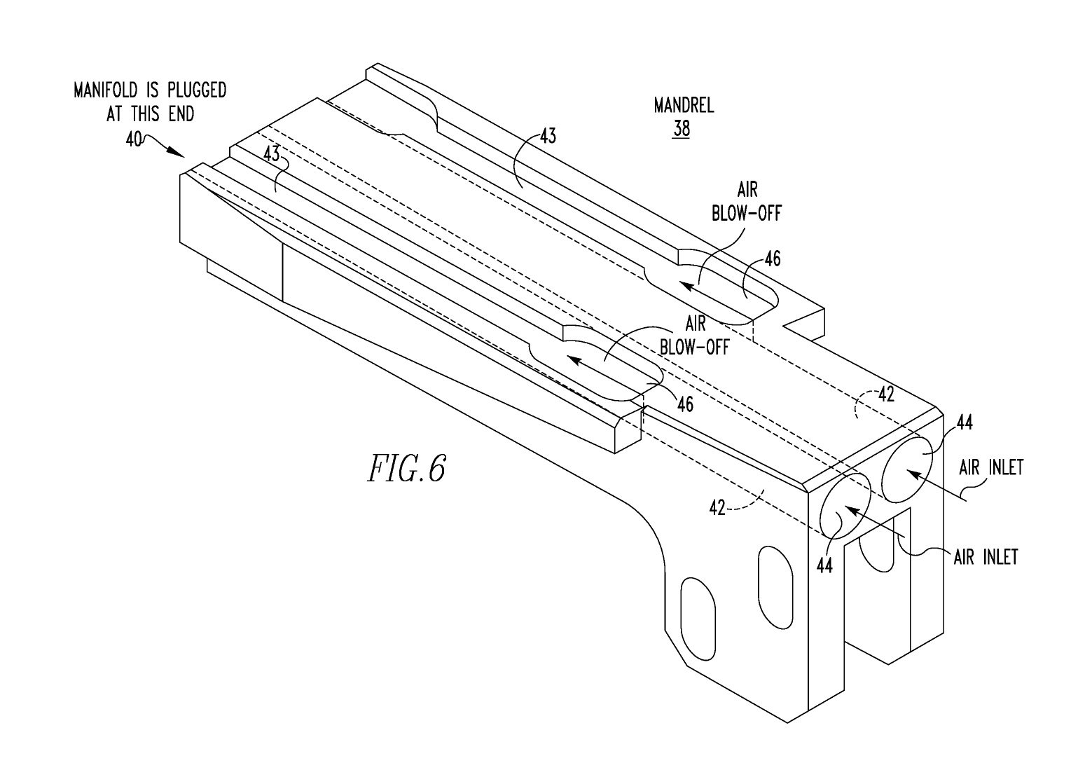

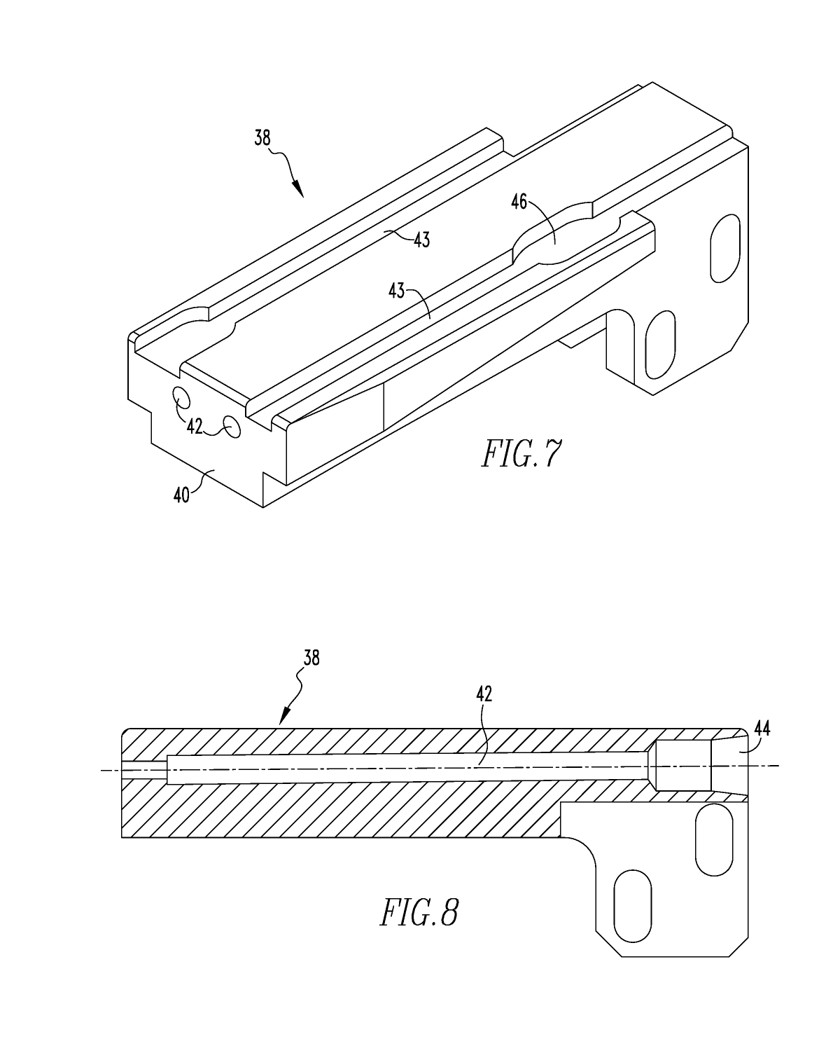

The present invention pertains to a riveting machine 36, as shown in FIGS. 6-8. The riveting machine comprises a punch 54 to push against a rivet 22 and insert the rivet 22 into an assembly 34. The riveting machine 36 comprises an anvil 38 having a flat top 40 which the rivet 22 contacts. The anvil 38 has an inward channel 42 with an inlet 44 that extends through the anvil 38 to the flat top 40 and an outward channel 43 with an outlet that extends from the flat top 40 through the anvil 38. The riveting machine 36 comprises a pressurized gas source that is connected to the inlet 44 through which pressurized gas flows to the flat top 40 and from the flat top 40 through the outward channel 43 to the outlet 46 to evacuate debris at the flat top 40.

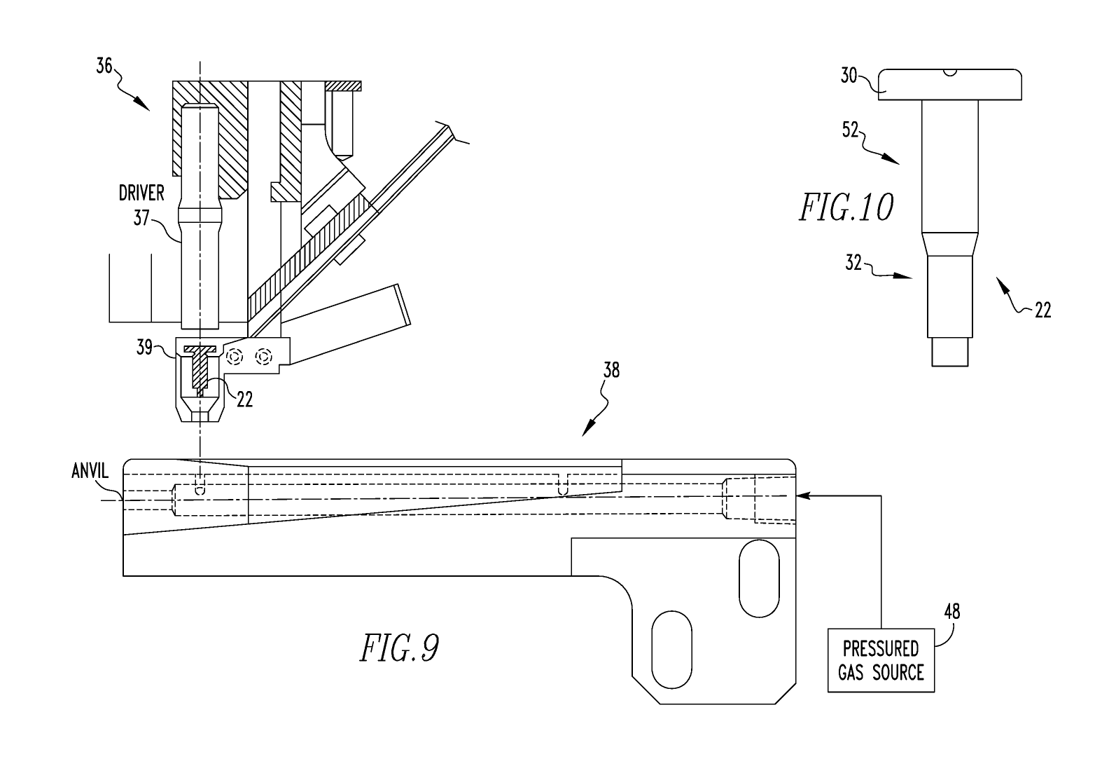

In the operation of the invention, the riveting process of the present invention, that attaches reinforced rubber or soft composite to aluminum extrusions, provides several rivet 22 fastening enhancements. The aluminum alloy selected for the solid rivet 22 in combination with the temper allows the rivet 22 shank 52 to act as a punch for aluminum extrusions versus pre-drilling. The rivet upset 28 volume and interference fit directly result in a fastening system performance improvement. Additionally, the dog point taper at the bottom tip 32 of the rivet 22, as shown in FIG. 9, creates an improved interference fit between the aluminum extrusion 14 and aluminum rivet 22. The flat rivet 22 shank 52 tip 32 of the dog point allows an aluminum slug to punch cleanly from an extrusion 14 leaving the barb 26 on the exit side of the extrusion 14 formed from this aluminum slug of the extrusion 14. The barb 26 forms from the extrusion 14 material itself that is pushed out from the rivet 22 punching through the extrusion 14 and forming around the exit hole 24 produced by the rivet 22, as shown in FIG. 3. The rivet 22 punching process of the rivet 22 moving through the extrusion 14, locally work hardens the extrusion 14 about the formed hole 24 and increases the performance of the hole 24 to reduce crack propagation and/or material tearing. The barb 26 and work hardened hole 24 of the extrusion 14 work together as another fastening system performance improvement. Additionally, the rivet 22 shank 52 swells in the reinforced rubber/soft composite layer 16 and has shown to help reduce rivet 22 movement during cycle testing.

Notably, if the shear strength of the extrusion 14 increases, then the rivet 22 compression yield strength requires a proportional increase to ensure the rivet 22 does not upset prematurely. The rivet 22 is used as a punch and does not need a pre-drilling operation. The rivet 22 material compression yield strength is increased for the punching process. The rivet 22 pushout performance is enhanced by larger net upset, locally work hardened hole 24, a barb 26 on the exit side of the hole 24 and an improved interference fit. The process also reduces crack propagation due to the rivet 22 hole 24 being locally work hardened.

This riveting process, which utilizes a high compressive strength aluminum rivet 22 as a punch, is unique. Upsetting the rivet 22 just after it punches through extrusions is unique. Creating an interference fit as a result of the dog point without pre-drilling is unique. Locally work hardening the rivet 22 hole 24 as a result of a punching process is unique. Creating a barb 26 on the underside of the hole 24 to improve push-out performance is unique.

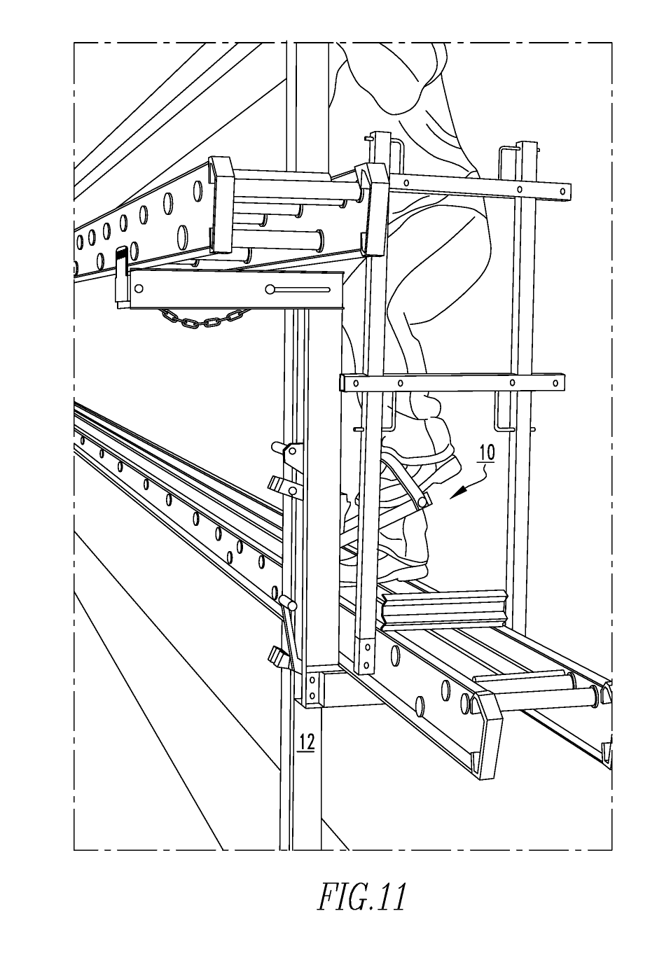

The cold headed rivet 22 dimensions are typical to a standard dog point rivet 22. What is unique about this particular rivet 22 is the specific aluminum alloy 7050 and T73 heat treatment combination that is not currently recognized by ASTM B316. This and similar high compression yield strength alloys are ideal for this application. The rivet 22 begins to yield around 1000 lbs. The 6000 series rivet 22 cannot punch through the extrusion 14 whereas the 7050-T73 rivet 22 can. The rivet 22 needs to resist yielding while punching through the 6105-T6 (alternate material 6065-T6) extrusion 14 but can be formed just after it has punched through the extrusion 14 with a hardened flat tool steel anvil 38. The rivet 22 begins to fail in compression at about 1400 pounds compared to a 6000 series rivet that begins to fail at about 580 pounds. FIG. 10 shows the rivet 22 itself. The dimensions of the rivet 22 are as follows, although the various dimensions of the rivet 22 may vary depending on the requirements:

The diameter of the head 30 is about 0.7 inches and the thickness of the head 30 is about 0.1 inch;

The overall length of the shank 52, including the dog point taper is about 1 inch;

The length of the shank 52 from the head 30 to the beginning of the dog point taper is about 0.6 inch;

The length of the dog point taper is about 0.4 inch;

The diameter of the shank 52 is about 0.17 inches;

The diameter of the dog point taper is about 0.13 inches.

As shown in FIG. 9, the riveting machine's 36 capability (Superior Rivet Machine, Model #6000), modified to have channels in the anvil 38 to evacuate extrusion 14 upset debris, is able to drive a rivet 22 up to 6,000 lbs. of force. The requirements for this application are relatively ⅙th of what is needed. There is a driver 37 (model-Driver: Superior Rivet Machine, Part #1369-27 Jaws, Part #61011-28) that delivers the necessary force to punch the rubber and aluminum pole extrusion 14, then upset the rivet 22 end. Also there is a set of jaws 39 (part # above) that guides the rivet 22 just before it meets the rubber of the pole.

The work hardened hole 24 is formed when the rivet 22 punches through the extrusion 14 leaving behind a hole 24 with an exit side barb 26 that allows for higher interference when the rivet 22 is pushed through the extrusion 14 in the opposite way that it was installed.

The dog point taper creates an improved interference fit between the aluminum extrusion 14 and aluminum rivet 22. The smaller dog point is being used to initially punch through the aluminum extrusion 14; then the rivet 22 taper helps form the barb 26 and helps to maintain an interference fit on the shank 52 of the rivet 22.

As shown in FIG. 1, the rivet 22 shank 52 swells in the reinforced rubber/soft composite layer 16 due to the compression force from the driver forcing the rivet 22 shank 52 into compression yield, while in this soft state the rivet 22 continues to compress. The rivet 22 shank's length reduces while proportionately increasing the diameter of the shank 52. This is a volumetric change and can be described as the Poisson effect. The area within the soft composite resists less than the aluminum extrusion 14, therefor this areas swells or expands in this area more than the area in the extrusion's thickness.

The barb 26 and work hardened hole 24 of the extrusion 14 work together as another fastening system performance improvement. The barb 26 is a conical shape at the edge of the exit side of the rivet 22 hole 24. This raised barb 26 provides a higher localized stiffness that resists a higher amount of push-out force against the rivet's upset. Also, the holes are cold formed instead of drilled which supplements the barb's performance. Horizontal bend tests (see below) show an increase in resistance to hole 24 tear out/crack propagation. The resistance to crack propagation is a result of barb 26 and work hardened rivet 22 hole 24. In horizontal bend the rivet 22 hole 24 where the pole will fail since there is a high stress concentration on the rivet 22 hole 24 vs where there is no hole 24.

As shown in FIGS. 6, 7 and 8, the flat top 40 of the anvil 38 used to form the end of the rivet 22 and create the rivet upset 28 is made from a hardened tool steel. The dog point taper of the rivet 22 compresses against the flat top 40 of the anvil 38 alter having punched through the extrusion 14 to form the rivet upset 28. There are inward channels 42 and outward channels 43 in the anvil 38 that are used to pneumatically remove aluminum debris from the forming area at the top 40 just after each rivet 22 is set. The aluminum debris is from the extrusion aluminum upset that has been created by the rivet 22 punching through the extrusion 14 and pushing aluminum from the aluminum extrusion 14 out to create the barb 26 about the exit hole 24 on the extrusion 14. Whatever aluminum from this aluminum slug that is not part of the barb 26 is the aluminum debris that is removed pneumatically through the inward and outward channels in the anvil 38. Tubes from a pressurized gas source 48, such as pressurized air cylinders or an air pump are connected to the inlets 44 of the inward channels 42 in the anvil 38 to provide the pressurized air to pneumatically blow out the aluminum debris. The pressurized air blows out the aluminum debris through outlets 46 of the outward channels 43. The removal of the aluminum debris from the anvil 38 allows the next rivet 22 to be cleanly placed into the extrusion 18. The removal of aluminum debris is also unique. FIG. 9 is a block diagram of the rivet machine 36.

Pump Jack Pole Beam Test—24′ poles, 22′ test span. Loaded in the center.

### Rubber Side Down

| | |
|---|---|
| 600 Series Rivet | 7000 Series Rivet |
| test load to failure | test load to failure |

| | | | | | |
|---|---|---|---|---|---|
| #1 | failed @ | 893 lbs | #1 | failed @ | 913 lbs |
| #2 | failed @ | 884 lbs | #2 | failed @ | 903 lbs |
| #3 | failed @ | 846 lbs | #3 | failed @ | 919 lbs |

The chemical composition of the specific aluminum alloy 7050 rivet 22 is as follows:

| | | | | | | | | | Others | | |
|---|---|---|---|---|---|---|---|---|---|---|---|
| Si | Fe | Cu | Mn | Mg | Cr | Ni | Zn | Ti | Each | Total | Al (min) |
| 0.12 | 0.15 | 2.0-2.6 | 0.10 | 1.9-2.6 | 0.04 | — | 5.7-6.7 | 0.06 | 0.05 | 0.15 | Balance |

The following definitions further explain the invention.

Work hardened hole 24—A hole 24 whose inner surface 50 is harder (or of a higher temper) than the surrounding material because the hole 24 was formed by a punching or shearing operation.

Punched hole 24—a hole 24 formed by a punching operation which consist of a set of basic tools known as a Punch and a Die.

Cold formed hole 24—a hole 24 formed at ambient temperatures

Rivet upset 28—a locally yield rivet end (the end opposite the rivet head 30) formed in compression into a general bulb shape with a larger diameter than the original rivet shank 52.

Dog point upset—the end of the rivet 22 opposite the head 30 is made with a diameter smaller than that of the rest of the shank 52. When subjected to axial compression, the dog point will expand into a bulb shape whose diameter is larger than the rivet 22 shank 52.

Shank 52 upset—On a rivet 22 with a constant shank 52 diameter, the end opposite the head 30 of a rivet 22 will, when subjected to axial compression, expand into a bulb shape whose diameter is larger than the rivet 22 shank 52.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A pump jack pole comprising:
an aluminum extrusion having a first side and a second side;
a rubber or composite layer disposed along the second side of the extrusion; and
a rivet that extends through the rubber or composite layer and a hole in the extrusion to hold the rubber or composite layer to the second side of the extrusion, the extrusion having a barb disposed on the first side of the extrusion about the hole.

2. The pole of claim 1 wherein the rivet is a self-punching solid rivet.

3. The pole of claim 2 wherein the rivet has a rivet upset adjacent the first side of the extrusion.

4. The pole of claim 3 wherein the hole in the extrusion is work hardened.

5. The pole of claim 4 wherein the aluminum extrusion begins to yield in shear at less than 600 lbs. and the rivet that begins to yield in compression around 1,000 lbs.

6. The pole of claim 5 wherein the rivet has a head which is disposed in the rubber or composite layer below the rubber or composite layer's surface.

7. The pole of claim 6 wherein the rivet has a diameter that is larger in the rubber or composite layer than the diameter of the rivet in the extrusion.

8. The pole of claim 7 wherein the extrusion is a 6000 series aluminum and the rivet is a 7000 series aluminum alloy.

9. The pole of claim 8 wherein the rivet has an interference fit with the extrusion in the hole.

10. A pump jack pole comprising:
an aluminum extrusion having a first side and a second side;
a rubber or composite layer disposed along the second side of the extrusion; and
a self-punching solid rivet that extends through the extrusion and the rubber or composite layer to hold the rubber or composite layer to the second side of the extrusion, the extrusion not having a pre-drilled hole through which the rivet extends.

11. A pump jack pole comprising:
an aluminum extrusion having a first side and a second side;
a rubber or composite layer disposed along the second side of the extrusion; and
a rivet that extends through the rubber of composite layer and the extrusion to hold the rubber or composite layer to the second side of the extrusion, the rivet having a rivet upset adjacent the first side of the extrusion.

12. A pump jack pole comprising:
an aluminum extrusion that begins to yield in shear around 600 lbs. having a first side and a second side;
a rubber or composite layer disposed along the second side of the extrusion; and
a self-punching solid rivet that begins to yield in compression around 1,000 lbs. and extends through the rubber or composite layer and the extrusion to hold the rubber or composite layer to the second side of the extrusion, the extrusion not having a pre-drilled hole through which the river extends.

13. A pump jack pole comprising:
an aluminum extrusion having a first side and a second side;
a rubber or composite layer disposed along the second side of the extrusion; and
a rivet that extends through the rubber or composite layer and a work hardened hole in the extrusion to hold the rubber or composite layer to the second side of the extrusion.

14. A method for forming pump jack pole comprising the steps of:
positioning a solid rivet held by a rivet machine over a rubber or composite layer disposed on a second side of an aluminum extrusion;
punching the solid rivet with the rivet machine through the rubber or composite layer and the extrusion thus forming with the rivet a work hardened hole in the extrusion and a barb disposed about the hole on a first side of the extrusion through which the rivet extends, with a rivet upset formed on an end of the rivet which is disposed above the barb by the end of the rivet contacting an anvil of the rivet machine as the rivet is punched through the extrusion, the extrusion not having a pre-drilled hole in which the solid rivet is disposed; and
removing the rubber or composite layer that is held in place on the second side of the extrusion with the rivet extending through the rubber or composite layer and the extrusion from the rivet machine.

15. The method of claim 14 including the step of removing extrusion slug upset.

16. The method of claim 15 wherein the rivet has a tip which is a dog point taper, and the punching step includes the step of punching the rivet through the rubber or composite layer with the tip of the rivet and forming the rivet upset from the tip.

17. A pump jack system comprising:
a pump jack pole comprising an aluminum extrusion having a first side and a second side, a rubber or composite layer disposed along the second side of the extrusion, and a rivet that extends through the rubber or composite layer and a hole in the extrusion to hold the rubber or composite layer to the second side of the extrusion, the extrusion having a barb disposed on the first side of the extrusion about the hole; and
a pump jack engaged with the pole so the pump Jack can move up and down the pole.
